(19) United States
(12) Patent Application Publication
(10) Pub. No.: US 2026/0235478 A1
(43) Pub. Date: Aug. 13, 2026

(54) HYBRID APPARATUS FOR SAMPLING FILTRATION MEDIA AND FLUIDS

(71) Applicant: De Nora Water Technologies, LLC, Colmar, PA (US)

(72) Inventors: Nicholas ARMSTRONG, East Hampstead, NH (US); Kenneth MARCHEK, Colorado Springs, CO (US)

(21) Appl. No.: 19/154,303

(22) PCT Filed: Feb. 7, 2024
(86) PCT No.: PCT/US2024/014871

§ 371 Date: Aug. 6, 2025

Related U.S. Application Data
(60) Provisional application No. 63/483,940, filed on Feb. 8, 2023.

(51) Int. Cl. G01N 1/20; G01N 1/10; G01N 1/40

(52) U.S. Cl. CPC G01N 1/2035; G01N 2001/1043; G01N 2001/205; G01N 2001/4088

(57) ABSTRACT

A hybrid apparatus for sampling filtration media and fluids in a fluid treatment vessel. The hybrid apparatus includes: a sampling conduit; and a fluid discharge piping, wherein a first end of the fluid discharge piping is coupled to a section of the sampling conduit. A first end of the sampling conduit is configured for slidable insertion within a fluid collection port of a fluid treatment vessel. The sampling conduit can include a media collection port at an anterior end and a media sampling/discharge valve at a posterior end. The media sampling valve can be configured to facilitate extraction of a desired amount of the filtration media for sampling purposes at any time during normal operation.

### FIELD OF THE INVENTION

The present invention relates to an apparatus for sampling filtration media and fluids in water treatment.

### BACKGROUND

The treatment of wastewater and sewage has been developed continuously since medieval times. Since the advent of municipal sewage systems, sewage plants have been built for the treatment of such waste on regional basis. Conventional water filtration involves having untreated fluid flow through an apparatus, such as, a vessel pressurized with water having an inlet, a bed of filter or filtration media, and an outlet drain arrangement for directing off the filtered water. The filtration media can be granular, such as sand, a biofilter, or a multimedia bed. The filtration media picks up a large amount of the solids contained in the water being filtered but allows the passage of water. Oxidation of organic and nitrogenous material in the fluid can also occur because of bacteria and other microorganisms which exist on the surfaces of the media of the bed.

The collection and buildup of layers of entrapped solids or biofilm on the filtration media prevents the wastewater from being in direct contact with the media and therefore reduces the efficacy of the filtration media. The solids form a layer on top of the filter as well as layers on the surfaces of the filtration media. This results in head loss and the unit must be cleaned in order to restore optimal performance to the filter again. Air and water backwash is required to effectively remove these solids. The filtration media is, therefore, periodically cleaned using a backwash that is forced through a drain arrangement and the backwashed liquid can be drawn off to waste above the level of the bed of filtration media.

Typically, samples of the filtration media and fluids are periodically collected to check the performance of the media and the quality of the purified fluid. Testing the media also allows for recommendations on what to do upstream, for example, if flow changes need to be made or if the media is not performing correctly. While fluid samples can be drawn during normal operations of the water treatment system, conventional methods of filtration sampling media require depressurizing the treatment vessel, opening it, and taking a sample from the top opening of the vessel. This involves operational downtime when the fluid treatment is halted. Conventionally, a media sample cannot be withdrawn during normal operation of the water treatment system or without the need to open the vessel.

Accordingly, there is a need for an apparatus that can sample both the media and the fluid during normal operation of the water treatment system.

### SUMMARY OF THE INVENTION

In accordance with one or more embodiments, the invention relates to a hybrid apparatus for sampling both filtration media and fluids in a fluid treatment vessel.

One embodiment of the invention is a hybrid apparatus for sampling filtration media and fluids. The hybrid apparatus includes: a sampling conduit; and a fluid discharge piping, wherein a first end of the fluid discharge piping is coupled to a section of the sampling conduit. The hybrid apparatus can have a generally L-shaped structure. The hybrid apparatus has a first end of the sampling conduit configured for slidable insertion within a fluid collection port of a fluid treatment vessel, and the fluid treatment vessel can include a filtration media and a fluid. The sampling conduit can include a media collection port at an anterior end and a media sampling/discharge valve at a posterior end. The media sampling valve can be located outside the fluid treatment vessel. Additionally, the media sampling valve can be configured to facilitate extraction of a desired amount of the filtration media for sampling purposes.

The hybrid apparatus can have a second end of the fluid discharge piping terminate in a fluid outlet. The fluid outlet can be configured to facilitate extraction of a desired amount of the fluid for sampling purposes. Additionally, the first end of the fluid discharge tube can be coupled to the sampling conduit at a 90-degree angle.

The sampling conduit can include a fluid collection screen for separation of the filtration media from the fluid, and the fluid collection screen can be located proximal to the media collection port. The sampling conduit includes: a media sampling tube; and a fluid collection pipe, wherein the inner diameter of the fluid collection pipe is larger than the outer diameter of the media sampling tube. The separated fluid is configured for passage in an annulus formed between the media sampling tube and the fluid collection pipe.

Another embodiment of the invention includes a fitting element, which can be configured to couple the media sampling tube to the fluid collection screen. A distal end of the fitting element is compression fitted within a groove located on an anterior end of the fluid collection screen. The fitting element includes a pass-through central channel and the media sampling tube is received within the central channel. The hybrid apparatus can include a ferrule for clamping down on the media sampling tube.

The hybrid apparatus can also include a fluid sampling valve located proximal to a fluid outlet.

Another embodiment of the invention is a method of sampling filtration media and fluids. The method involves providing the hybrid apparatus described herein, and inserting a first end of the hybrid apparatus within a fluid collection port of a fluid treatment vessel, wherein the fluid treatment vessel includes a filtration media and a fluid.

The method can include actuating a media sampling valve and/or a fluid sampling valve; and collecting the filtration media and/or the fluid from the pressurized vessel at any time during normal operation.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The invention will be described in further detail below and with reference to the attached drawings all of which describe or relate to apparatus, systems and methods of the present invention. In the figures, which are not intended to be drawn to scale, each similar component that is illustrated in various figures is represented by a like numeral. In the figures:

FIG. 1 depicts a hybrid apparatus for sampling filtration media and fluids according to an embodiment.

FIG. 2 depicts a media collection port for the hybrid apparatus for sampling filtration media and fluids according to another embodiment.

FIG. 3 depicts a fitting element for the hybrid apparatus for sampling filtration media and fluids according to another embodiment.

FIG. 4 depicts a media sampling valve and media sampling tube for the hybrid apparatus for sampling filtration media and fluids according to another embodiment.

FIG. 5 depicts a water treatment system with the hybrid apparatus for sampling filtration media and fluids according to an embodiment.

FIG. 6 depicts a water treatment system with the hybrid apparatus for sampling filtration media and fluids according to an embodiment.

### DETAILED DESCRIPTION OF THE INVENTION

Depending on the context, all references below to the “invention” may in some cases refer to certain specific embodiments only. Various terms are used herein. To the extent a term used in a claim is not defined below, it should be given the broadest definition persons in the pertinent art have given that term as reflected in printed publications and issued patents at the time of filing.

A hybrid apparatus for sampling filtration media and fluids is disclosed herein. As used herein, the term “hybrid apparatus” is intended to encompass a multi-functional apparatus, such as, an apparatus that allows sampling of both the fluid and filtration media in a water treatment system. The hybrid apparatus for sampling filtration media and fluids (hereinafter referred to interchangeably as “hybrid apparatus”) can be configured to facilitate the sampling of fluids and filtration media simultaneously or individually.

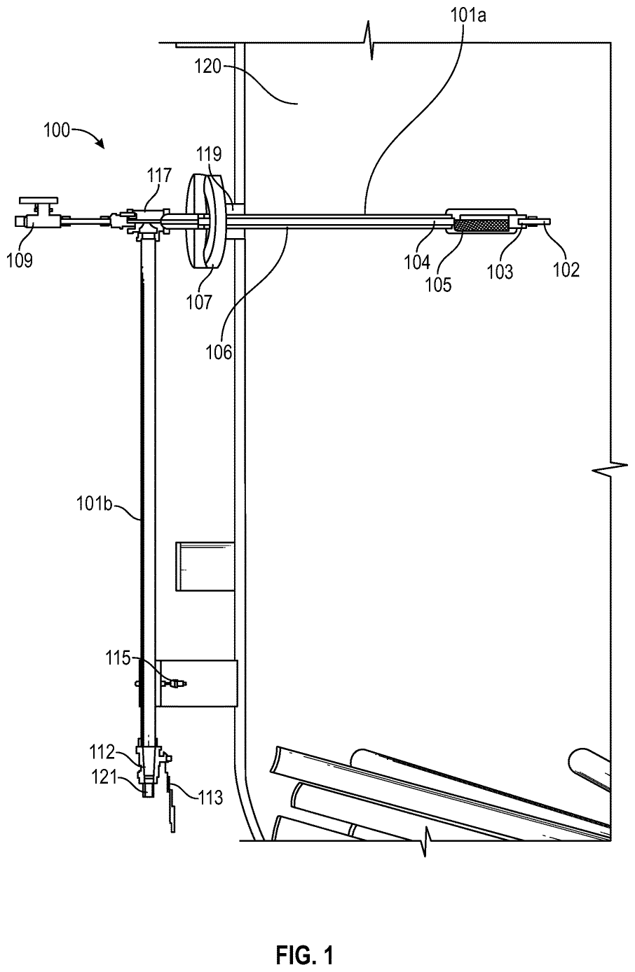

Now referring to FIG. 1, the hybrid apparatus 100 has a generally L-shaped structure. However, it is understood that the hybrid apparatus 100 can have any other suitable structure or shape. The hybrid apparatus 100 includes a filtration media and fluid sampling conduit 101a (hereinafter interchangeably referred to as “sampling conduit 101a”) and a fluid discharge piping 101b. A first end of the fluid discharge piping 101b can be coupled to a section of the sampling conduit 101a at a 90-degree angle while a second end of the piping 101b terminates in an opening 121 for discharging a desired 4 amount of the fluid for sampling or testing purposes. The sampling conduit 101a can be attached to a fluid treatment vessel 120 by a flange seal 107 using a set of bolts (not shown). The fluid treatment vessel can be a pressure vessel 120 which contains one or more filtration media and one or more fluids requiring filtration. A bracket 115 may be used to couple the fluid discharge piping 101b to the pressure vessel 120.

A first end of the sampling conduit 101a can be configured for slidable insertion within an existing fluid/liquid collection port 119 in the pressure vessel 120. The sampling conduit 101a has a media collection port 102 at an anterior end 108 and a media sampling/discharge valve 109 at a posterior end. The media sampling valve 109 is located outside the pressure vessel 120 for ease of extraction of the filtration media. Since the sampling conduit 101a can be inserted into an existing port, the hybrid apparatus 100 can allow samples of the filtration media to be extracted without requiring the water treatment system to be shut down.

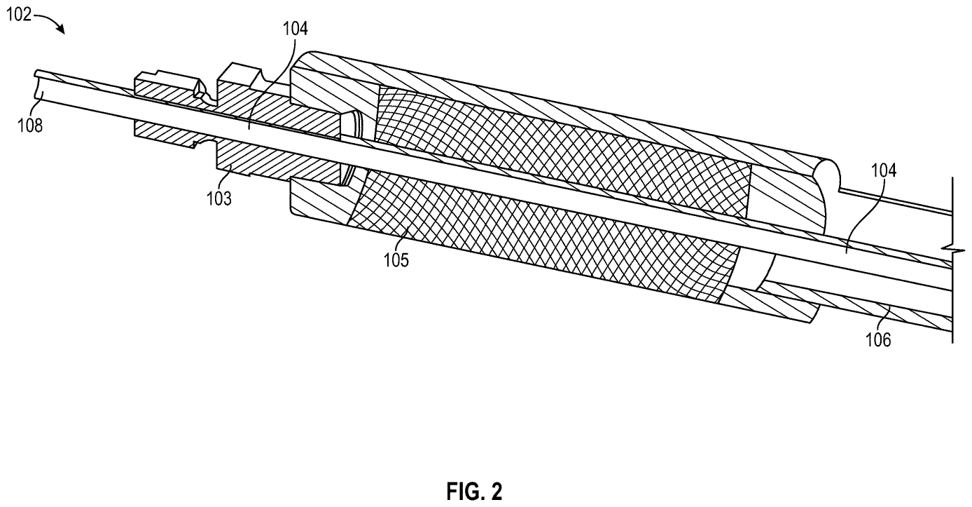

Now referring to FIGS. 1 and 2, the diameter of the media collection port 102 can be suitably sized to allow an influx of a desired amount of filtration media (now shown) contained within the vessel. The filtration media can flow through the port 102 and through the sampling conduit 101a.

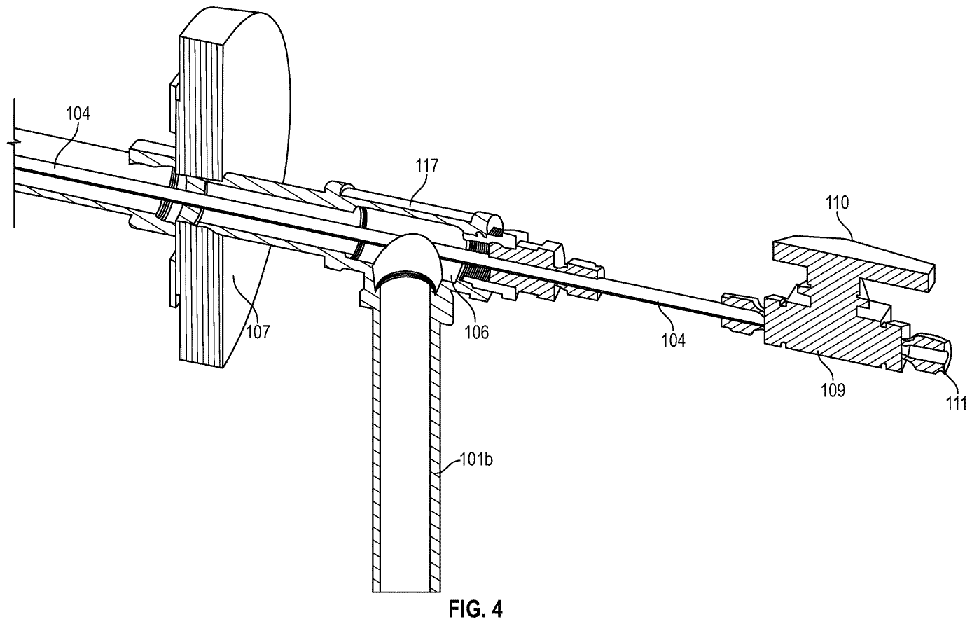

Now referring to FIGS. 1 and 4, the media sampling valve 109 is configured to allow a desired amount of the filtration media to be extracted/removed from the vessel 120 through outlet 111 for sampling or testing purposes. The media sampling valve 109 includes a handle 110. Advantageously, the media sampling valve 109 can be arranged in a horizontal or vertical orientation. Since vessel 120 is pressurized, the flow can occur in any of these valve orientations. A user can manually actuate the media sampling valve 109 by rotating the handle 110. In one or more embodiments, the actuation of the valve may be automated in response to a predetermined pressure differential across the valve. When the media sampling valve 109 is in an open configuration, the pressure differential across the valve causes the filtration media and fluid to be discharged from the outlet 111. When the media sampling valve 109 is in a closed configuration, the outflow of filtration media and fluid is paused. In one or more embodiments, the media sample valve 109 includes a tap (not shown) which can be opened or closed.

The sampling conduit 101a further includes a fluid collection screen 105 which will separate the fluid from the media. Fluid collection screens are known in the art. The fluid collection screen 105 is configured to separate fluid from filtration media. These screens can typically have a standardized screen hole size of 60 U.S. mesh (~0.01 inch or 250 microns). The size of resin beads (used in filter beds), on the other hand, commonly ranges from 300 to 1200 microns (16-50 U.S. mesh). Since the screen mesh size is smaller than the media size, only the fluid is allowed to pass through the fluid collection screen 105. When fluid sampling valve 112 is opened, the pressure differential in the system causes the fluid to flow through the screen 105 into the anulus of the sampling conduit 101a formed by a fluid collection pipe 106 or an outer conduit 106 and a media sampling tube or an inner conduit 104. The fluid collection pipe 106 has a larger inner diameter than the outer diameter of the media sampling tube 104 thereby facilitating the passage of fluid through the annulus. The fluid collection screen 105 is located proximal to media collection port 102 and is configured to envelope at least a portion of both the media sampling tube 104 and the fluid collection pipe 106.

The isolated or separated fluid is allowed to flow through the fluid collection screen 105 into a T-junction connector 117. The connector 117 can be any conventional coupling device known in the art. The fluid then flows into the fluid discharge piping 101b and the fluid sampling valve 112. The fluid sampling valve 112 is located proximal to fluid outlet 121. As shown in FIG. 1, the fluid sampling valve 112 includes a valve handle 113. Similar to the media sampling valve 109, the fluid sampling valve 112 can be manually actuated by a user by rotating the valve handle 113. When the fluid sampling valve 112 is in an open configuration, the pressure differential across the valve causes the fluid to be discharged from the outlet 121. When the fluid sampling valve 112 is in a closed configuration, the outflow of fluid is paused. In one or more embodiments, the fluid sampling valve 112 includes a tap (not shown) which can be opened or closed.

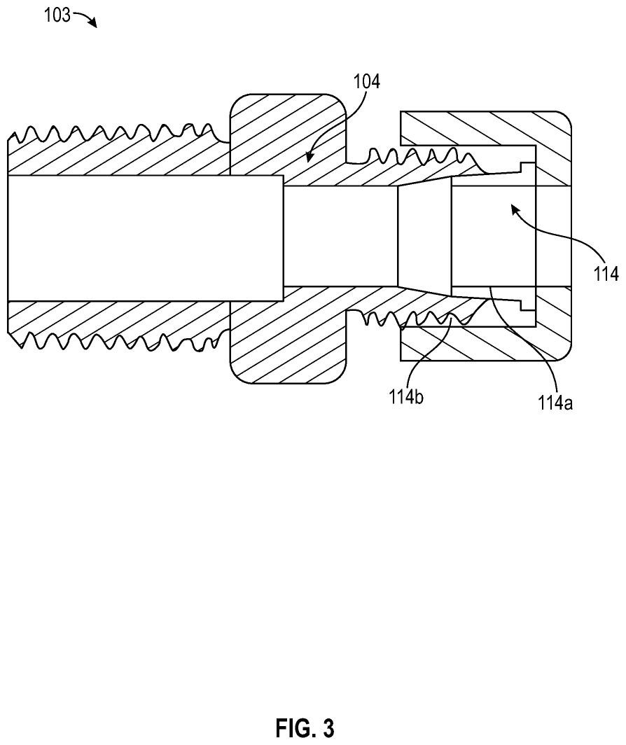

The hybrid apparatus 100 further includes a fitting element 103. As shown in FIG. 3, the fitting element 103 is configured to couple the media sampling tube 104 and the fluid collection screen 105. A distal end of the fitting element 103 can be compression fitted within a groove located on an anterior end of the fluid collection screen 105. The fitting element 103 is configured to allow the media sampling tube 104 to remain usable without deforming it. The fitting element 103 includes a pass-through central channel 116 for receiving the media sampling tube 104. As shown, in one embodiment, the fitting element 103 does not have a tube stop, which allows the tube 104 to pass through the fitting element 103 itself. Additionally, a ferrule 114 can be used to clamp down on the media sampling tube 104, which is configured to meet an upper flange 114a and a lower flange 114b. The ferrule 114 can ensure that the media sampling tube 104 is not damaged in the pressurized vessel 120, which allows for continuous flow of the fluid and media in the hybrid apparatus 100 and serviceability for the apparatus. In one embodiment, the ferrule 114 can be made of plastic or a composite material so as not to damage the sampling tube 104 when installed. Since the connection feeds into the fluid collection pipe 106, a small leak at the fitting element 103 and fluid collection screen 105 junction is insignificant. The fitting element 103 can have a seal that is configured to keep the filtration media from entering the fluid collection pipe 106.

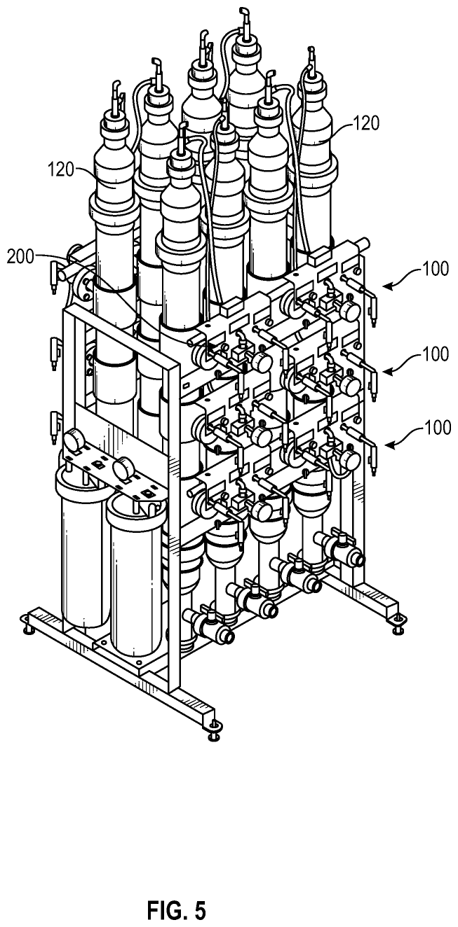

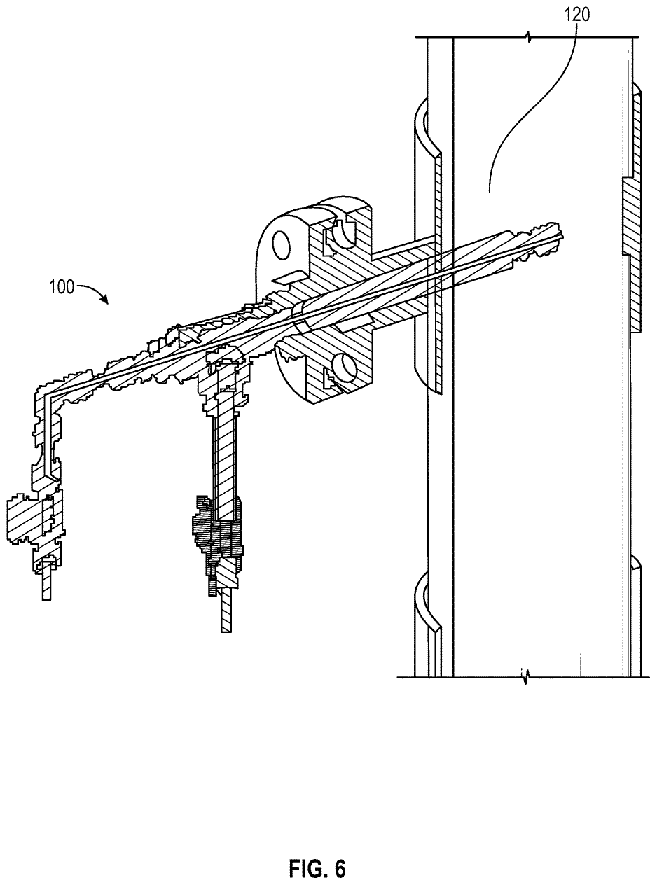

As shown in FIGS. 5-6, a water treatment system 200 can include multiple pressure vessels or columns 120. One or more hybrid apparatus 100 can be attached to each vessel. For instance, in one embodiment, at least three hybrid apparatus 100 can be inserted at a plurality of ports in each vessel. Typically, a pressurized water column vessel has a plurality of segments with existing ports at 25-50-75 percent fluid capacity heights. A portion of the hybrid apparatus 100 can be slidably inserted within each of these ports such that the desired fluid and filtration media samples can be extracted.

In another embodiment, a method of sampling filtration media and fluids in a pressure/pressurized vessel involves providing the hybrid apparatus 100 described herein. A portion of the hybrid apparatus 100 can be slidably inserted within one or more existing ports in the pressure vessel. The user may collect the filtration media and/or the fluid from the vessel at any time during normal operation, without having to shut down the operation and opening the vessel to extract the filtration media, by actuating the media sampling valve and/or the fluid collection valve. When the valves are in an open configuration, a desired amount of filtration media and/or fluid can be collected for testing purposes. Additionally, if the user needs to test filtration media that is located deeper within the vessel, the user can insert a probe (not shown) into the media sample port and extract samples across the cross section of the vessel. The probe comprises a smaller diameter tubing than the internal diameter of the media sampling tube 104. Any fluid that is collected from the probe will be extracted from the end of the probe allowing sampling across the media bed.

Therefore, the present invention is well adapted to attain the ends and advantages mentioned as well as those that are inherent therein. The previous description is not intended to limit the invention, which may be used according to different aspects or embodiments without departing from the scope thereof. The discussion of acts, materials, devices, articles and the like are included in this specification solely for the purpose of providing a context for the present invention. It is not suggested or represented that any or all of these matters formed part of the prior art base or were common general knowledge in the field relevant to the present invention.

Furthermore, the particular illustrative embodiments disclosed above may be altered or modified and all such variations are considered within the scope and spirit of the present invention. While systems and methods are described in terms of “comprising,” “containing,” or “including” various devices/components or steps, it is understood that the systems and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. If there is any conflict in the usages of a word or term in this specification and one or more patent(s) or other documents that may be incorporated herein by reference, the definitions that are consistent with this specification should be adopted.

1. A hybrid apparatus for sampling filtration media and fluids comprising:
a sampling conduit; and
a fluid discharge piping, wherein a first end of the fluid discharge piping is coupled to a section of the sampling conduit.

2. The hybrid apparatus according to claim 1, wherein a first end of the sampling conduit is configured for slidable insertion within a fluid collection port of a fluid treatment vessel, wherein the fluid treatment vessel includes a filtration media and a fluid.

3. The hybrid apparatus according to claim 2, wherein the sampling conduit includes a media collection port at an anterior end and a media sampling/discharge valve at a posterior end.

4. The hybrid apparatus according to claim 3, wherein the media sampling valve is located outside the fluid treatment vessel.

5. The hybrid apparatus according to claim 4, wherein the media sampling valve is configured to facilitate extraction of a desired amount of the filtration media for sampling purposes.

6. The hybrid apparatus according to claim 2, wherein the sampling conduit includes a fluid collection screen for separation of the filtration media from the fluid, and wherein the fluid collection screen is located proximal to the media collection port.

7. The hybrid apparatus according to claim 6, wherein the sampling conduit includes:
a media sampling tube; and
a fluid collection pipe, wherein an inner diameter of the fluid collection pipe is larger than am outer diameter of the media sampling tube.

8. The hybrid apparatus according to claim 7, wherein the separated fluid is configured for passage in an annulus formed between the media sampling tube and the fluid collection pipe.

9. The hybrid apparatus according to claim 6, further comprising a fitting element configured to couple the media sampling tube to the fluid collection screen.

10. The hybrid apparatus according to claim 9, wherein a distal end of the fitting element is compression fitted within a groove located on an anterior end of the fluid collection screen.

11. The hybrid apparatus according to claim 10, wherein the fitting element includes a pass through central channel.

12. The hybrid apparatus according to claim 11, wherein the media sampling tube is received within the central channel.

13. The hybrid apparatus according to claim 11, further comprising a ferrule for clamping down on the media sampling tube.

14. The hybrid apparatus according to claim 2, wherein a second end of the fluid discharge piping terminates in a fluid outlet, and wherein the fluid outlet is configured to facilitate extraction of a desired amount of the fluid for sampling purposes.

15. The hybrid apparatus according to claim 14, further comprising a fluid sampling valve located proximal to a fluid outlet.

16. The hybrid apparatus according to claim 1, wherein the hybrid apparatus has a generally L-shaped structure.

17. The hybrid apparatus according to claim 1, wherein the first end of the fluid discharge piping is coupled to the sampling conduit at a 90-degree angle.

18. A method of sampling filtration media and fluids comprising:
providing the hybrid apparatus according to claim 1; and
inserting a first end of the hybrid apparatus within a fluid collection port of a fluid treatment vessel, wherein the fluid treatment vessel includes a filtration media and a fluid.

19. The method according to claim 18, further comprising:
actuating a media sampling valve and/or a fluid sampling valve; and
collecting the filtration media and/or the fluid from the fluid treatment vessel at any time during normal operation.
